(19) United States
(12) Patent Application Publication
(10) Pub. No.: US 2017/0239137 A1
(43) Pub. Date: Aug. 24, 2017

(54) STEAM GENERATOR ELEMENT FOR A SAUNA ELECTRIC HEATER AND A SAUNA ELECTRIC HEATER

(71) Applicant: Helo Oy, Riihimaki (FI)

(72) Inventors: Jan Björkbom, Riihimaki (FI); Peter Sjölund, Riihimaki (FI)

(73) Assignee: Helo Oy, Riihimaki (FI)

(21) Appl. No.: 15/438,442

(22) Filed: Feb. 21, 2017

(30) Foreign Application Priority Data
Feb. 19, 2016 (EM) 16156447.1

(51) Int. Cl. A61H 33/02; F22B 1/28

(52) U.S. Cl. CPC A61H 33/02; F22B 1/284; A61H 2201/0207

(57) ABSTRACT

The present invention relates to bathing devices for special therapeutic or hygienic purposes such as e.g. sauna or Finnish baths, and especially to a steam generator element for a sauna electric heater and a sauna electric heater. A sauna electric heater (13) according to the present invention comprises comprising a frame part (14), heating resistor elements (15-17), (29), (30), (54), (55) inside the said frame part (14), and sauna stones (2) arranged inside the said frame part (14) and/or on the top part of the said sauna electric heater (13), which said sauna electric heater (13) comprises a steam generator element (18), (19), (26), (33), (37), (45), (52), (62) placed inside the said frame part (14) between at least two heating resistor elements (15-17), (29), (30), (54), (55) and/or said sauna stones (2), said steam generator element (18), (19), (26), (33), (37), (45), (52), (62) comprising a water tank (20), (27), (38), (46), (53) fillable with water. The sauna electric heater according to the present invention provides more durable operation and with less generated faults and brake ups when compared to the prior art solutions.

### FIELD OF THE INVENTION

The present invention relates to bathing devices for special therapeutic or hygienic purposes such as e.g. sauna or Finnish baths, and especially to a steam generator element for a sauna electric heater and a sauna electric heater.

### BACKGROUND OF THE INVENTION

Traditional sauna, also referred to as Finnish bath or a steam room, originated in Finland. There are two main types of traditional Finnish saunas, firstly saunas with wood burning sauna heaters and secondly saunas with sauna electric heaters. Both of these sauna heaters provide radiating heat to the sauna room and also heat up sauna stones in the top part of the said heater. A traditional way for generating sudden hot steam in a traditional sauna is to use a dipper to scoop water onto the hot sauna stones.

The prior art will be described in the following in greater detail with reference to the accompanying figures, in which:

FIG. 1 shows a perspective view of a sauna electric heater according to prior art; and

FIG. 2 shows a block diagram of a sauna electric heater with a steam generator according to prior art.

FIG. 1 shows a perspective view of a sauna electric heater according to prior art. The sauna electric heater according to prior art comprises a frame part 1 and a layer of stones 2 arranged on the top part of the said sauna electric heater. The sauna electric heater according to prior art also comprises heating resistor elements inside the said frame part 1. The heating resistor elements provide radiating heat which radiating heat heats up the said layer of stones 2 arranged on the top part of the said sauna electric heater.

The main use of a sauna electric heater is to release heat to direct heated sauna room temperature. When using sauna is typical fashion there is poured water onto the said layer of hot stones 2. One traditional way is to use a dipper to scoop water onto the said layer of sauna stones 2. The water evaporates from the said layer of stones 2, this suddenly releasing a large amount of steam into the sauna room.

FIG. 2 shows a block diagram of a sauna electric heater with a steam generator according to prior art. The presented sauna electric heater arrangement according to prior art has a sauna electric heater 3 being complemented with a steam generator element 4, in which the steam generator element 4 is placed adjacent to the sauna electric heater 3. The sauna electric heater 3 according to prior art comprises a frame part 5 and heating resistor elements 6-8 inside the said frame part 5. The heating resistor elements 6-8 provide radiating heat which radiating heat heats up a layer of stones of the said sauna electric heater 3.

The steam generator element 4 according to prior art comprises a frame part 9 which frame part 9 is filled with water. The steam generator element 4 according to prior art also comprises a heating resistor element 10 inside the said frame part 9. The steam generator element 4 according to prior art provides steam to the sauna by heating up the said heating resistor element 10 and thereby warming the water in the water filled frame part 9 of the steam generator element 4. Consequently, the water evaporates and produces steam to the sauna. The steam generator element 4 complements the soothing heat of a traditional sauna electric heater 3 with an infusion of soft steam provided by the said steam generator element 4.

The steam generator element 4 of the presented sauna electric heater arrangement according to prior art also comprises a temperature measurement probe 11 in the water filled frame part 9 of the steam generator element 4. Furthermore, the steam generator element 4 comprises a control block 12 for controlling the steam generation of the steam generator element 4. The control block 12 of the steam generator element 4 is typically used for controlling the water level of the water filled frame part 9 as well as for emptying the frame part 9 from water.

There are several problems with the prior art steam generators and with prior art sauna electric heaters having a steam generator. The current steam generator solutions are quite complex and the comprise a lot of electronical solutions in heating the water for providing steam as well as for controlling the water level of the water filled frame part as well as for emptying the frame part from water.

The current steam generator solutions are easily generating faults and brake up quite easily usually due to lack of cleaning up and maintenance. Therefore, there is a need for a steam generator solution and for a sauna electric heater having a steam generator, which would be a simpler and more straight-forward solution, not prone to generating faults and braking up.

The problem therefore is to find a design and configuration for a steam generator which can produce soft steam to the sauna and which also is simpler in design and which configuration are not prone to generating faults and braking up.

There is a demand in the market for a steam generator, which steam generator can produce soft steam to the sauna while still providing more durable operation and with less generated faults and brake ups when compared to the prior art solutions.

### BRIEF DESCRIPTION OF THE INVENTION

An object of the present invention is thus to provide a method and an apparatus for implementing the method so as to overcome the above problems and to alleviate the above disadvantages.

The objects of the invention are achieved by a steam generator element for a sauna electric heater, said sauna electric heater comprising a frame part, heating resistor elements inside the said frame part, and sauna stones arranged inside the said frame part and/or on the top part of the said sauna electric heater, which said steam generator element comprises a water tank fillable with water and being placeable inside the said frame part between at least two heating resistor elements and/or said sauna stones.

Preferably, said water tank is manufactured from a metal sheet or from a metal alloy sheet with joined form pressed side plates. Preferably, said steam generator element comprises a water tank cover comprising openings. Preferably, said water tank cover is manufactured from a form pressed metal sheet or from a form pressed metal alloy sheet.

Preferably, said water tank and/or the said water tank cover comprise one or more water level mark. Preferably, said water tank cover comprises a recess for a diffuser of oils or solutions.

The objects of the invention are also achieved by a sauna electric heater comprising a frame part, heating resistor elements inside the said frame part, and sauna stones arranged inside the said frame part and/or on the top part of the said sauna electric heater, which said sauna electric heater comprises a steam generator element placed inside the said frame part between at least two heating resistor elements and/or said sauna stones, said steam generator element comprising a water tank fillable with water.

Preferably, in said sauna electric heater said water tank and/or the said water tank cover comprise one or more water level mark. Preferably, said steam generator element comprises: a heat-proof pipe element connected to the bottom part of the said water tank; and/or a heat-proof hose comprising a transparent element and a water level mark. Preferably, said steam generator element comprises a heat-proof syphon pipe.

Preferably, said sauna electric heater comprises: a control unit for regulating the water level of said water tank of said steam generator element, the said a control unit comprising a water inlet and a control block for controlling the said water inlet; and that it comprises a water inlet pipe/hose arrangement leading the water from the said water inlet to said heat-proof hose and/or said heat-proof pipe element.

Further preferably, said sauna electric heater comprises at least two water level sensors, each water level sensor of the at least two water level sensors being arranged to detect a level of water in the water tank. Alternatively, said sauna electric heater comprises a movable water level sensor and a sensor pipe connected to one end of said heat-proof hose and/or to one end of said heat-proof pipe element, the movable water level sensor being arranged to move up and down along the said sensor pipe.

Further preferably, said movable water level sensor detects when the water has risen to the level of a first water level mark showing the filling level of water in the water tank or to the level of a second water level mark showing the draining level of water in the water tank. Further preferably, said movable water level sensor detects when the water level is at a desirable level for regulating the amount of steam generated by the said steam generator element.

### BRIEF DESCRIPTION OF THE DRAWINGS

FIG. 1 shows a perspective view of a sauna electric heater according to prior art;

FIG. 2 shows a block diagram of a sauna electric heater with a steam generator according to prior art;

FIG. 3 shows a block diagram of a sauna electric heater with a steam generator according to the present invention;

FIG. 4 shows a perspective view of one embodiment of a steam generator element for a sauna electric heater according to the present invention;

FIG. 5 shows a top view of one embodiment of a water tank cover of a steam generator element according to the present invention;

FIG. 6 shows one embodiment for filling up a water tank of a steam generator element for a sauna electric heater according to the present invention;

FIG. 7 shows a perspective view of another embodiment of a steam generator element for a sauna electric heater according to the present invention;

FIG. 8 shows a top view of another embodiment of a water tank cover of a steam generator element according to the present invention;

FIG. 9 shows a perspective view of one embodiment of a sauna is electric heater according to the present invention;

FIG. 10 shows a perspective view of another embodiment of a sauna electric heater according to the present invention without sauna stones;

FIG. 11 shows another embodiment for filling up and emptying a water tank of a steam generator element for a sauna electric heater according to the present invention;

FIG. 12 shows a perspective view of a third embodiment of a steam generator element for a sauna electric heater according to the present invention;

FIG. 13 shows a perspective cut open view of a third embodiment of a steam generator element for a sauna electric heater according to the present invention;

FIG. 14 shows a third embodiment for filling up and emptying a water tank of a steam generator element for a sauna electric heater according to the present invention;

FIG. 15 shows an embodiment for regulating the water level of a water tank of a steam generator element for a sauna electric heater according to the present invention;

FIG. 16 shows another embodiment for regulating the water level of a water tank of a steam generator element for a sauna electric heater according to the present invention.

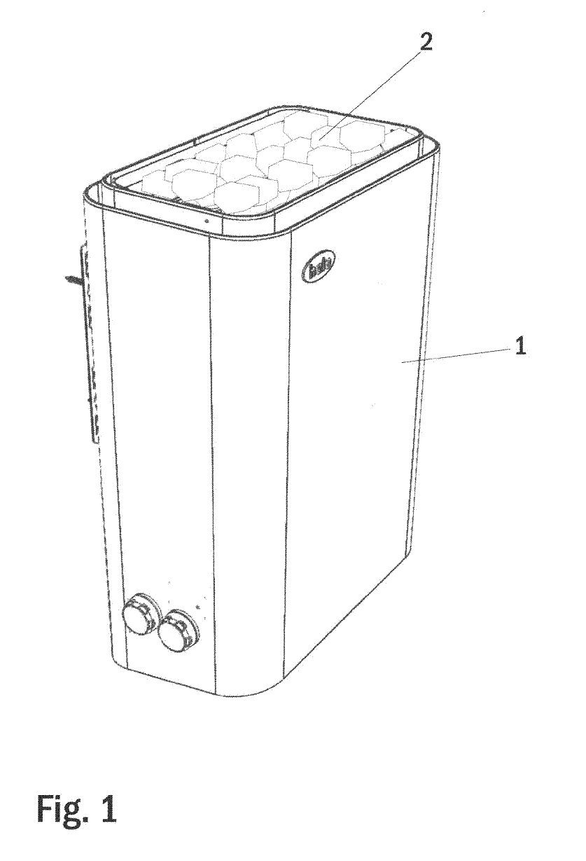

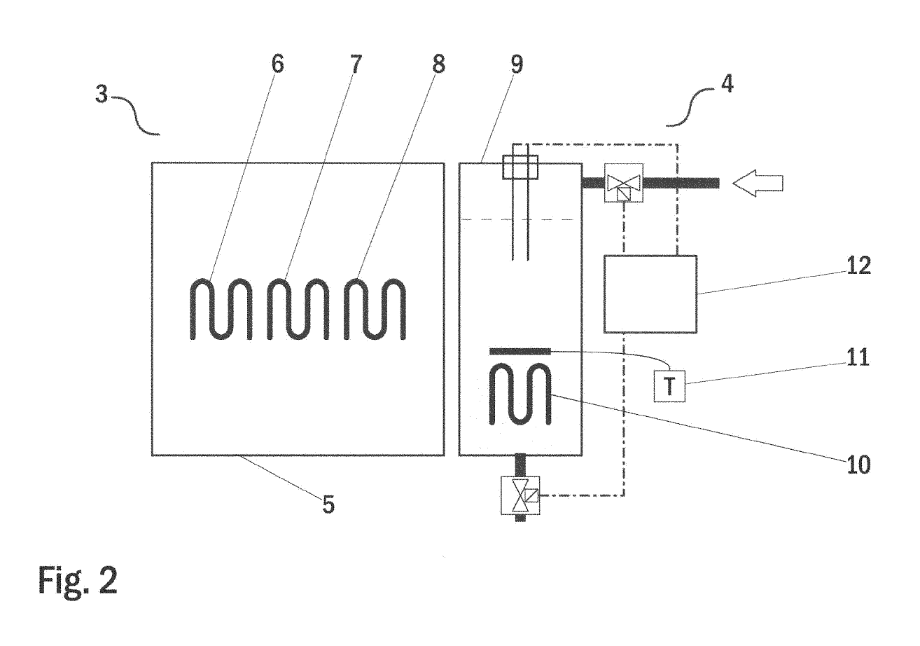

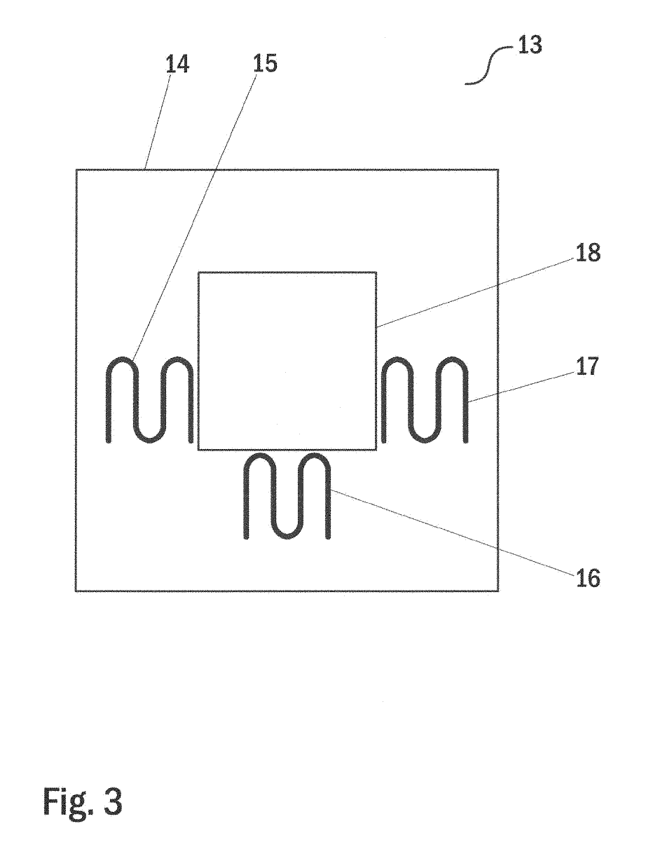

FIGS. 1 to 2 are presented above. Some embodiments of the invention will now be described in greater detail by means of some preferred embodiments, with reference to FIGS. 3 to 16.

### DETAILED DESCRIPTION OF THE INVENTION

FIG. 3 shows a block diagram of a sauna electric heater according to the present invention. The sauna electric heater 13 according to the present invention comprises a frame part 14 and heating resistor elements 15-17 inside the said frame part 14 and sauna stones arranged inside the said frame part 14 and/or on the top part of the said sauna electric heater. The sauna electric heater 13 according to the present invention also comprises a steam generator element 18, which steam generator element 18 is placeable inside the said frame part 14 between at least two of the said heating resistor elements 15-17 and/or said sauna stones. The steam generator element 18 according to the present invention utilizes the heat generated and radiated by the heating resistor elements 15-17 of the sauna electric heater 13 in generating steam to the sauna. Consequently, the water evaporates and produces steam to the sauna. The steam generator element 18 complements the soothing heat of a sauna electric heater 13 with an infusion of soft steam provided by the said steam generator element 18.

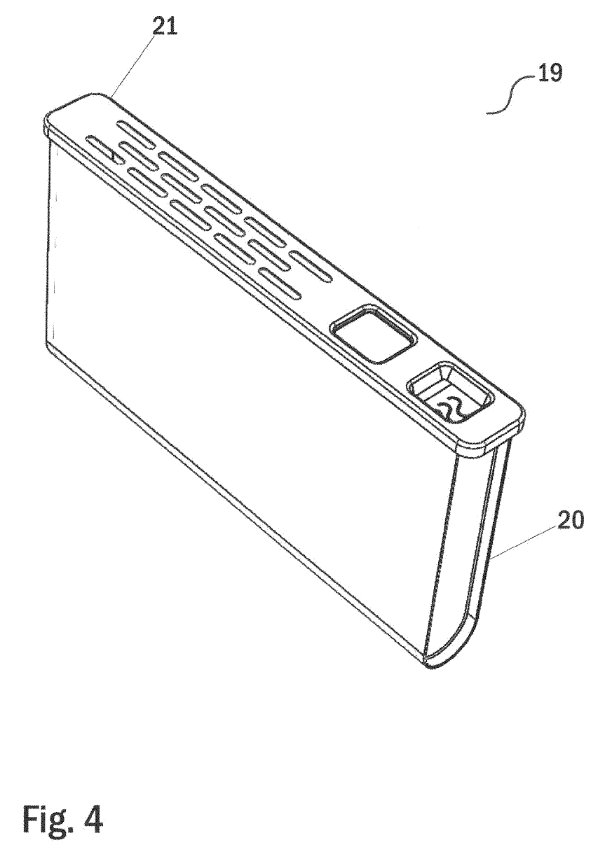

FIG. 4 shows a perspective view of one embodiment of a steam generator element for a sauna electric heater according to the present invention. The steam generator element 19 according to the present invention comprises a water tank 20 Tillable with water. Said water tank 20 of the said steam generator element 19 is placeable inside the sauna electric heater frame part between at least two of the heating resistor elements and/or sauna stones of the said sauna electric heater. The steam generator element 19 according to the present invention utilizes the heat generated and radiated by the heating resistor elements of the sauna electric heater in generating steam from said water tank 20 to the sauna. Said water tank 20 may be manufactured from a metal sheet or from a metal alloy sheet with joined form pressed side plates. As presented in FIG. 4 said water tank 20 may be manufactured from a bended metal sheet or from a bended metal alloy sheet with joined side plates, said bended metal sheet or said bended metal alloy sheet forming a front face and a back face of said water tank 20. As presented in FIG. 4 said bended metal sheet or said bended metal alloy sheet may be bended to a U-form. Said water tank 20 may have a holding capacity or 1.0 to 3.0 liters, preferably a holding capacity or 1.5 to 2.0 liters. The steam generator element 19 according to the present embodiment also comprises a water tank cover 21.

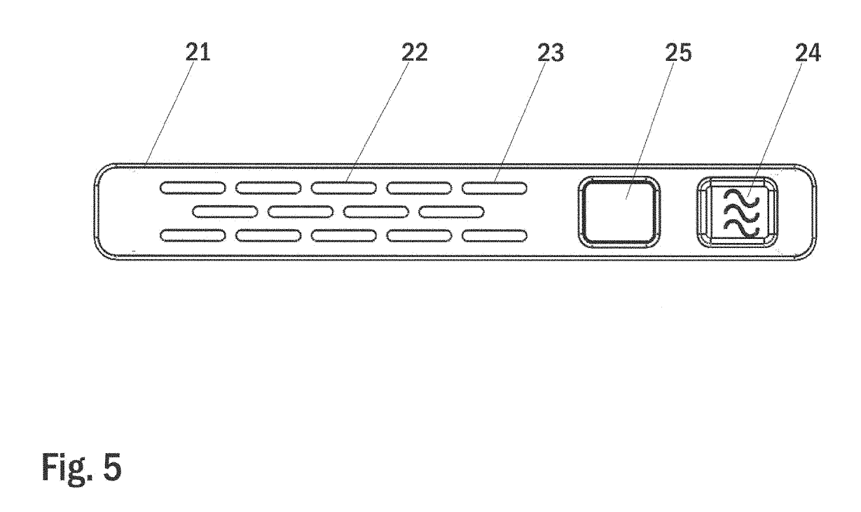

FIG. 5 shows a top view of one embodiment of a water tank cover of a steam generator element according to the present invention. The water tank cover 21 according to the present embodiment comprises openings 22, 23 for steam generated from the from the water tank to the sauna. The openings 22, 23 may be e.g. slot type openings 22, 23. The water tank cover 21 according to the present embodiment also comprises one or more water level mark 24 for marking the level of water in the water tank. Furthermore, the water tank cover 21 according to the present embodiment comprises a recess 25 for a diffuser of oils or solutions such as e.g. essential oils, ethereal oils, aromatic oils or fragrances. Said water tank cover 21 may be manufactured from a form pressed metal sheet or from a form pressed metal alloy sheet.

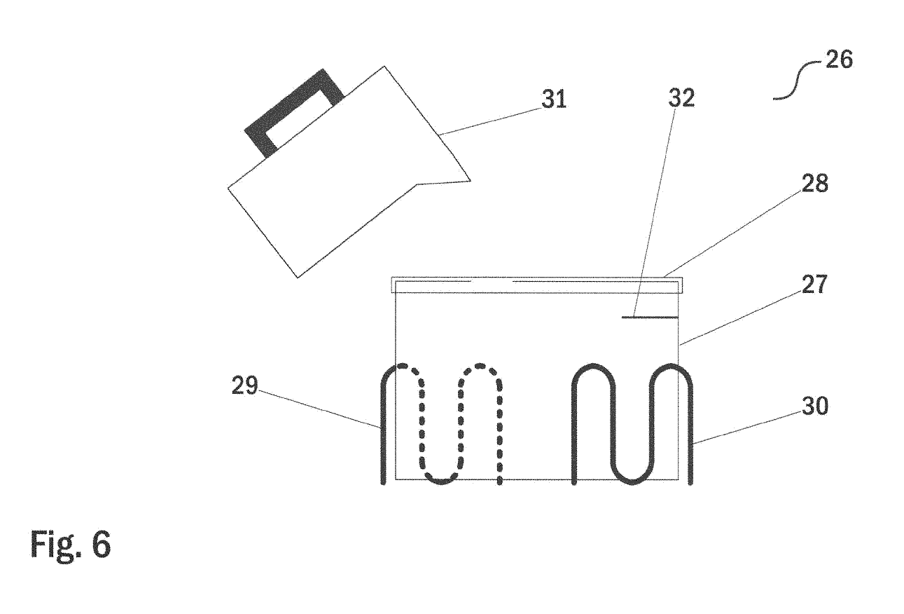

FIG. 6 shows one embodiment for filling up a water tank of a steam generator element for a sauna electric heater according to the present invention. The steam generator element 26 according to the present embodiment comprises a water tank 27 fillable with water and a water tank cover 28. Said water tank 27 of the said steam generator element 26 is placeable inside the sauna electric heater frame part between at least two of the heating resistor elements 29, 30 of the said sauna electric heater. Said water tank 27 of the said steam generator element 26 is filled with water e.g. with a water jug 31.

The water tank cover 28 according to the present embodiment also comprises a water level mark 32 for marking the filling level of water in the water tank 27. The steam generator element 26 according to the present embodiment utilizes the heat generated and radiated by the heating resistor elements 29, 30 of the sauna electric heater in generating steam from said water tank 27 to the sauna. The steam generator element 26 complements the soothing heat of a sauna electric heater with an infusion of soft steam provided by the said steam generator element 26.

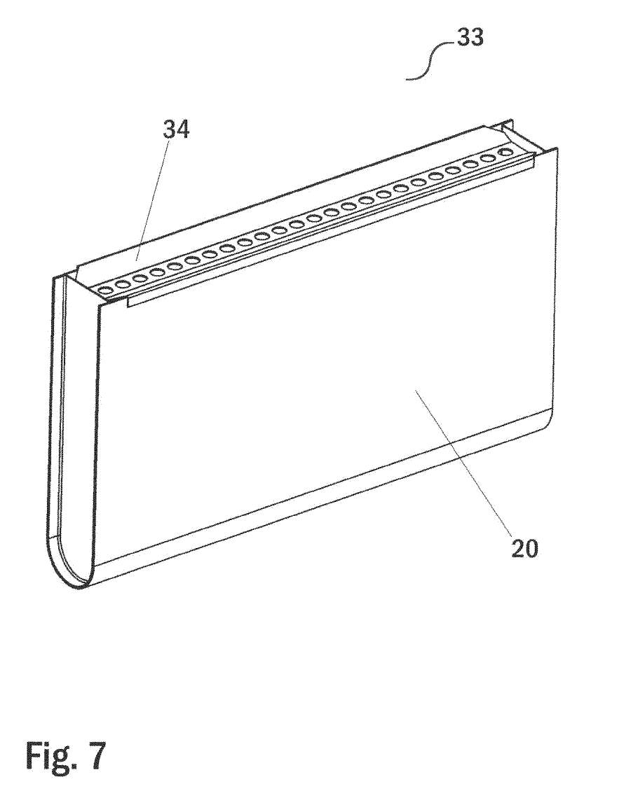

FIG. 7 shows a perspective view of another embodiment of a steam generator element for a sauna electric heater according to the present invention. The steam generator element 33 according to the present another embodiment comprises a water tank 20 fillable with water. Said water tank 20 of the said steam generator element 33 is placeable inside the sauna electric heater frame part between at least two of the heating resistor elements and/or sauna stones of the said sauna electric heater. The steam generator element 33 according to the present another invention utilizes the heat generated and radiated by the heating resistor elements of the sauna electric heater in generating steam from said water tank 20 to the sauna. Said water tank 20 may be manufactured from a metal sheet or from a metal alloy sheet with joined form pressed side plates. The steam generator element 33 according to the present another embodiment also comprises a water tank cover 34.

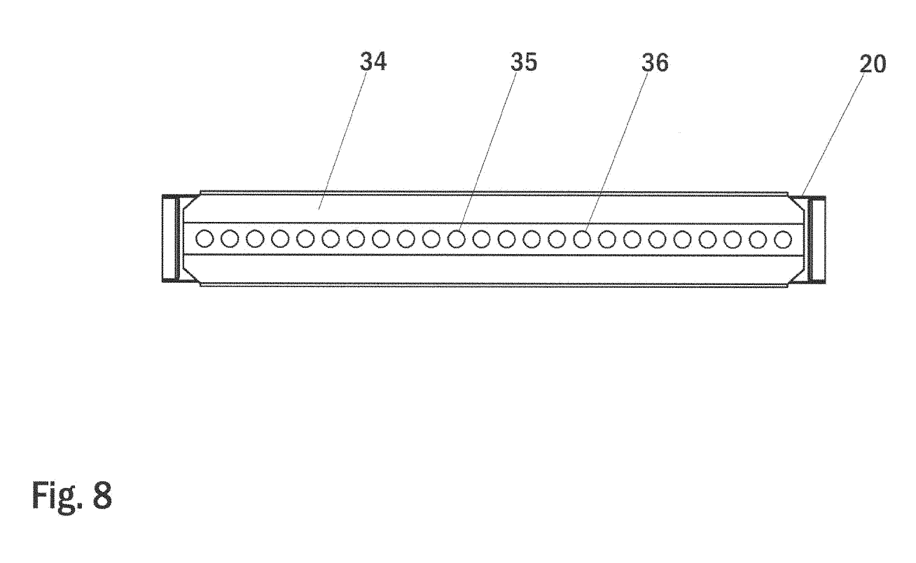

FIG. 8 shows a top view of another embodiment of a water tank cover of a steam generator element according to the present invention. The water tank cover 34 according to the present another embodiment comprises openings 35, 36 for steam generated from the from the water tank 20 to the sauna. The openings 35, 36 may be e.g. hole type openings 35, 36. Said water tank cover 34 may be manufactured from a form pressed metal sheet or from a form pressed metal alloy sheet,

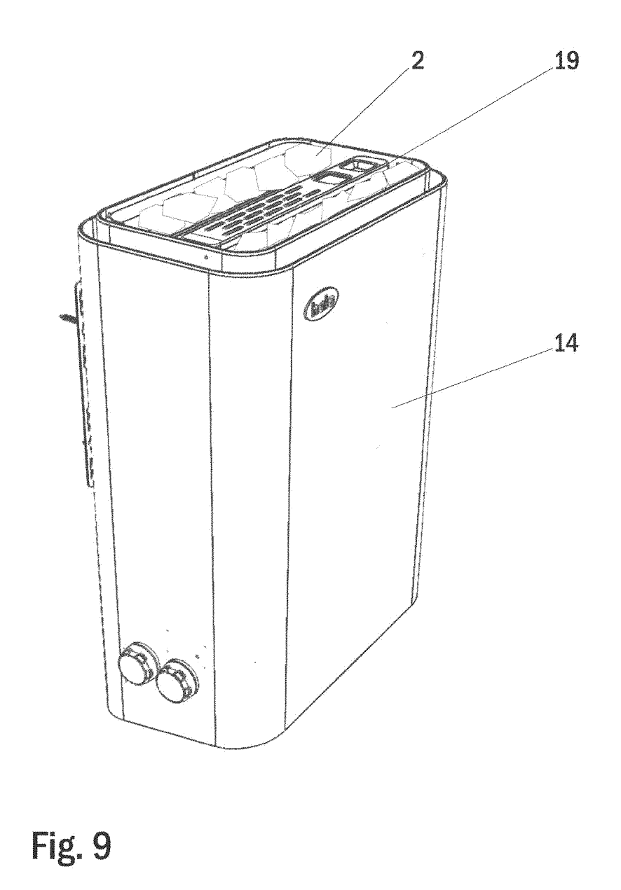

FIG. 9 shows a perspective view of one embodiment of a sauna electric heater according to the present invention. The sauna electric heater according to present embodiment comprises a frame part 14 and heating resistor elements inside the said frame part 14 and sauna stones 2 arranged inside the said frame part 14 and/or on the top part of the said sauna electric heater.

The sauna electric heater according to the present embodiment also comprises a steam generator element 19, which steam generator element 19 is placed inside the said frame part 14 between at least two of the said heating resistor elements and/or said sauna stones 2. The said sauna stones 2 arranged on the top part of the said sauna electric heater may leave the steam generator element 19 visible. Alternatively, the said sauna stones 2 arranged on the top part of the said sauna electric heater cover the steam generator element 19 wholly or partially. The heating resistor elements provide radiating heat which radiating heat heats up the said sauna stones 2 arranged inside the said frame part 14 and/or on the top part of the said sauna electric heater.

The main use of a sauna electric heater is to release heat to direct heated sauna room temperature. When using sauna is typical fashion there is poured water onto the said layer of hot stones 2. One traditional way is to use a dipper to scoop water onto the said layer of sauna stones 2. The water evaporates from the said layer of stones 2, this suddenly releasing a large amount of steam into the sauna room. The steam generator element 19 according to the present invention utilizes the heat generated and radiated by the heating resistor elements of the sauna electric heater in generating steam to the sauna, Consequently, the water evaporates and produces steam to the sauna. The steam generator element 19 complements the soothing heat of a sauna electric heater with an infusion of soft steam provided by the said steam generator element 19.

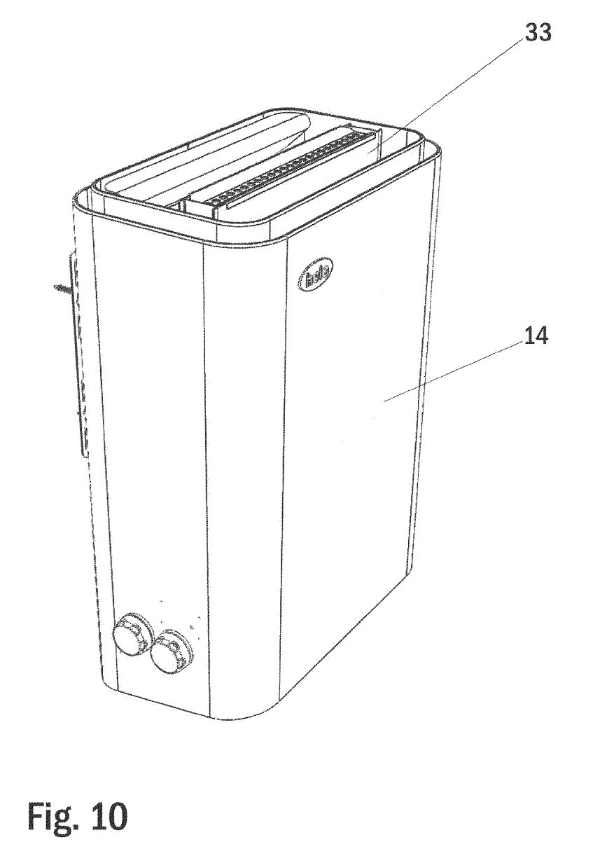

FIG. 10 shows a perspective view of another embodiment of a sauna electric heater according to the present invention without sauna stones. The sauna electric heater according to present another embodiment comprises a frame part 14 and heating resistor elements inside the said frame part 14 and sauna stones arranged inside the said frame part 14 and/or on the top part of the said sauna electric heater.

The sauna electric heater according to the present another embodiment also comprises a steam generator element 33, which steam generator element 33 is placed inside the said frame part 14 between at least two of the said heating resistor elements and/or said sauna stones. In the FIG. 10 sauna stones are not shown. The said sauna stones arranged on the top part of the said sauna electric heater may leave the steam generator element 33 visible. Alternatively, the said sauna stones arranged on the top part of the said sauna electric heater cover the steam generator element 33 wholly or partially. The heating resistor elements provide radiating heat which radiating heat heats up the said sauna stones arranged inside the said frame part 14 and/or on the top part of the said sauna electric heater.

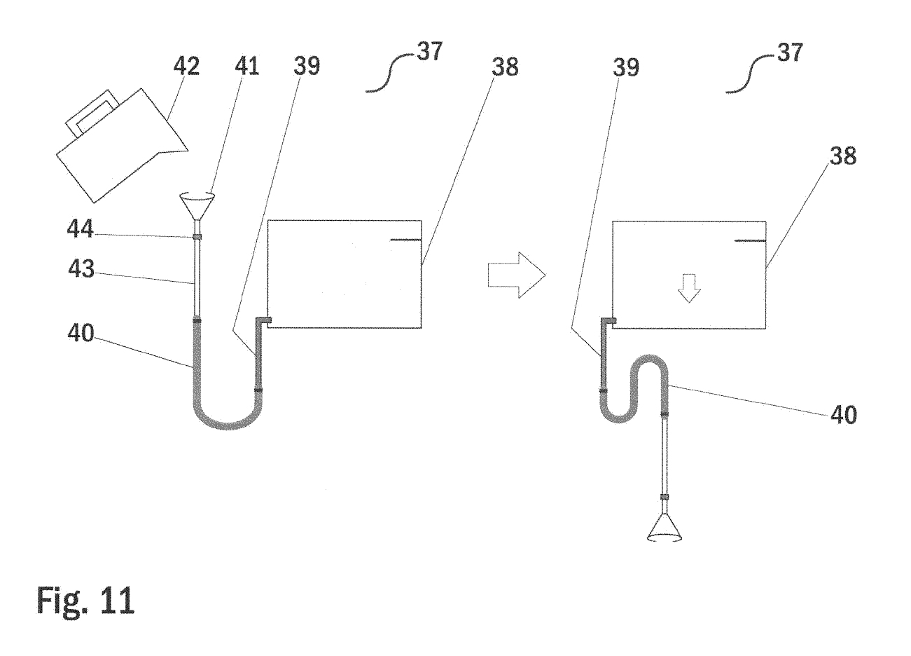

FIG. 11 shows another embodiment for filling up and emptying a water tank of a steam generator element for a sauna electric heater according to the present invention. The steam generator element 37 according to the present embodiment comprises a water tank 38 fillable with water. Said water tank 38 of the said steam generator element 37 is placeable inside the sauna electric heater frame part between at least two of the heating resistor elements of the said sauna electric heater.

Said water tank 38 of the said steam generator element 37 according to the present another embodiment comprises a heat-proof pipe element 39. In the present another embodiment the heat-proof pipe element 39 is connected from one end to the bottom part of the water tank 38 and has in the other end a heat-proof hose 40. The said heat-proof hose 40 may also have a funnel 41 which said funnel facilitates the filling of the said water tank 38 of the said steam generator element 37 e.g. by pouring water into the said funnel 41 with a water jug 42. The said heat-proof hose 40 may be attached to a mounting position next to said sauna electric heater. Furthermore, said heat-proof hose 40 may also comprise a transparent element 43 and a water level mark 44 for marking the filling level of water in the water tank 38. Said water tank 38 of the said steam generator element 37 is filled with water e.g. with a water jug 42 as illustrated in the first part of FIG. 11.

Said water tank 38 of the said steam generator element 37 according to the present another embodiment is emptied by detaching the said heatproof hose 40 from its mounting position and turning the said heat-proof hose 40 towards the floor to have the said water tank 38 drained empty as illustrated in the second part of FIG. 11.

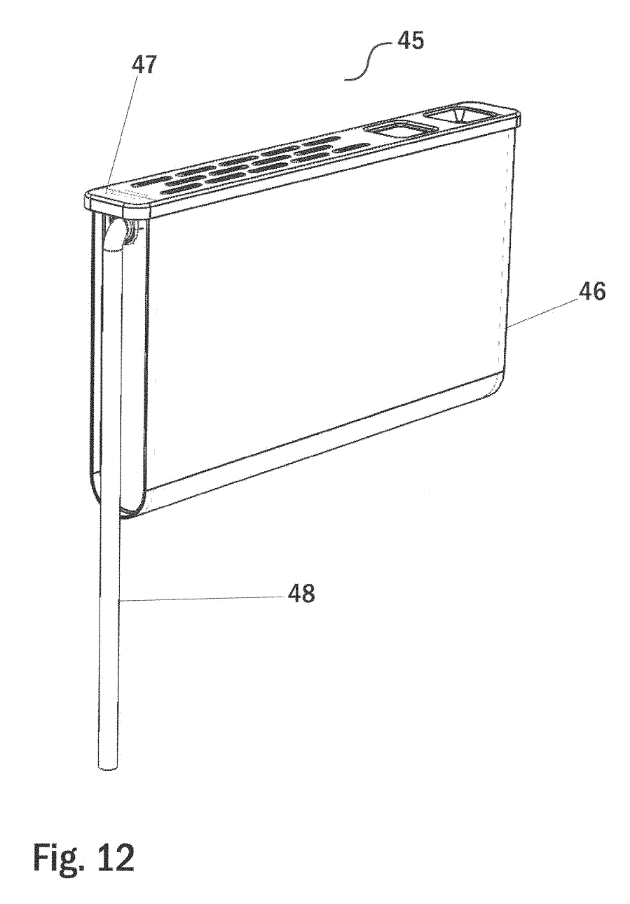

FIG. 12 shows a perspective view of a third embodiment of a steam generator element for a sauna electric heater according to the present invention. The steam generator element 45 according to the present invention comprises a water tank 46 fillable with water. Said water tank 46 of the said steam generator element 45 is placeable inside the sauna electric heater frame part between at least two of the heating resistor elements and/or sauna stones of the said sauna electric heater. The steam generator element 45 according to the present invention utilizes the heat generated and radiated by the heating resistor elements of the sauna electric heater in generating steam from said water tank 46 to the sauna. The steam generator element 45 according to the present embodiment also comprises a water tank cover 47. The steam generator element 45 according to the present invention also comprises a heat-proof syphon pipe 48 which said syphon pipe 48 facilitates the emptying of the said water tank 46 of the said steam generator element 45.

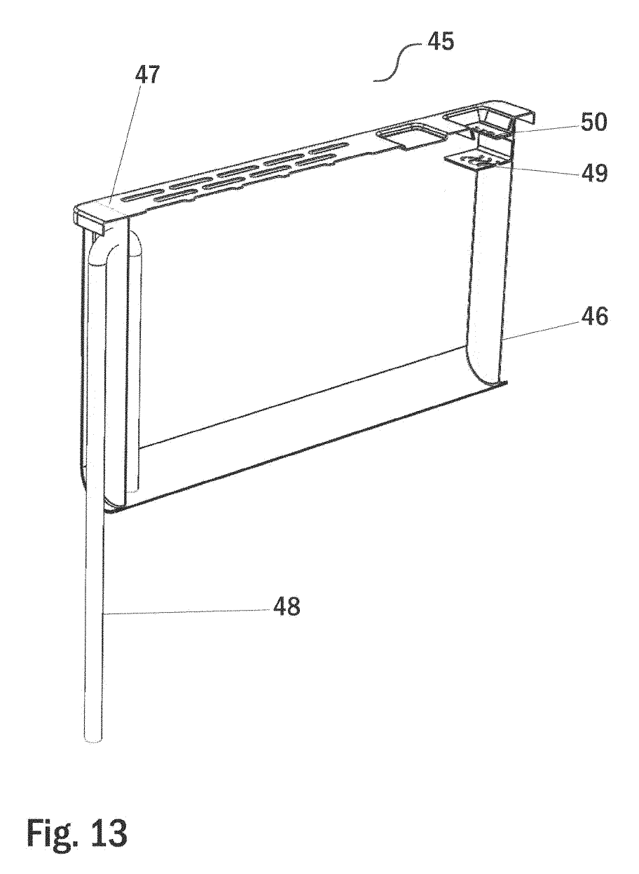

FIG. 13 shows a perspective cut open view of a third embodiment of a steam generator element for a sauna electric heater according to the present invention. The steam generator element 45 according to the present invention comprises a water tank 46 fillable with water. Said water tank 46 of the said steam generator element 45 is placeable inside the sauna electric heater frame part between at least two of the heating resistor elements and/or sauna stones of the said sauna electric heater. The steam generator element 45 according to the present invention utilizes the heat generated and radiated by the heating resistor elements of the sauna electric heater in generating steam from said water tank 46 to the sauna. The steam generator element 45 according to the present embodiment also comprises a water tank cover 47. The steam generator element 45 according to the present invention also comprises a heat-proof syphon pipe 48 which said syphon pipe 48 facilitates the emptying of the said water tank 46 of the said steam generator element 45.

The water tank 46 and/or the water tank cover 47 of the said steam generator element 45 according to the present embodiment also comprises one or more water level mark 49, 50 for marking the level of water in the water tank 46. In the cut open view of a third embodiment as presented in the FIG. 13 there is shown a first water level mark 49 showing the filling level of water in the water tank 46. Respectively, in the cut open view of a third embodiment as presented in the FIG. 13 there is shown a second water level mark 50 showing the emptying level of water in the water tank 46.

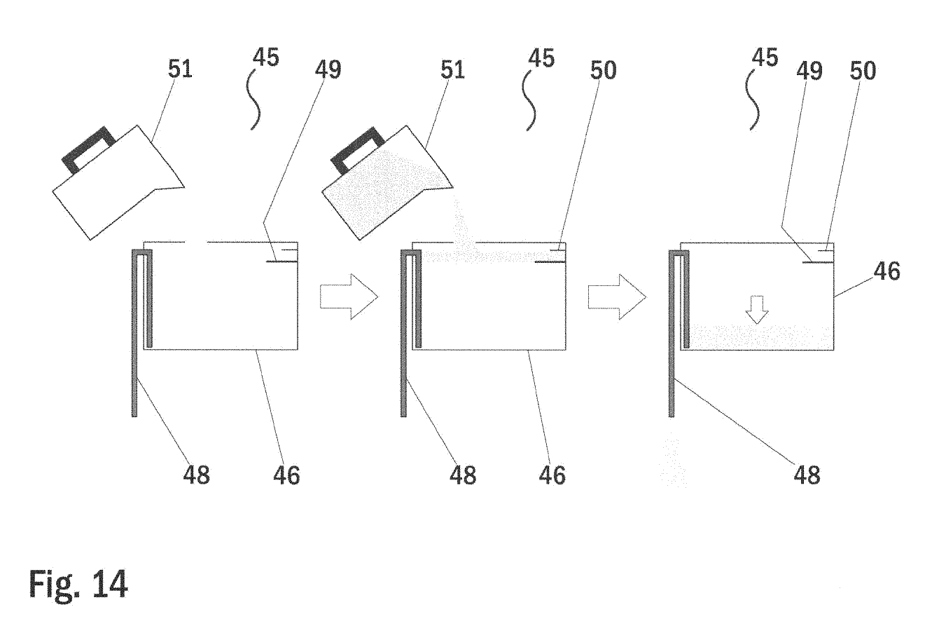

FIG. 14 shows a third embodiment for filling up and emptying a water tank of a steam generator element for a sauna electric heater according to the present invention. The steam generator element 45 according to the present third embodiment comprises a water tank 46 fillable with water. Said water tank 46 of the said steam generator element 45 is placeable inside the sauna electric heater frame part between at least two of the heating resistor elements of the said sauna electric heater. Said water tank 46 of the said steam generator element 45 according to the present third embodiment comprises a heat-proof syphon pipe 48.

The said steam generator element 45 according to the present embodiment also comprises one or more water level mark 49, 50 for marking the level of water in the water tank 46. As illustrated in the first part of FIG. 14 the said water tank 46 of the said steam generator element 45 may be filled with water e.g., with a water jug 51. In the FIG. 14 a first water level mark 49 shows the filling level of water in the water tank 46.

Respectively, as illustrated in the second part of FIG. 14 the emptying of the said water tank 46 of the said steam generator element 45 is initiated by filling the said water tank 46 to the draining level e.g. with a water jug 51. In the FIG. 14 a second water level mark 50 shows the draining level of water in the water tank 46.

When the water is filled to the draining level marked by said second water level mark 50 the said syphon pipe 48 starts the process of emptying of the said water tank 46. The syphon emptying process of the water tank 46 is illustrated in the third part of FIG. 14.

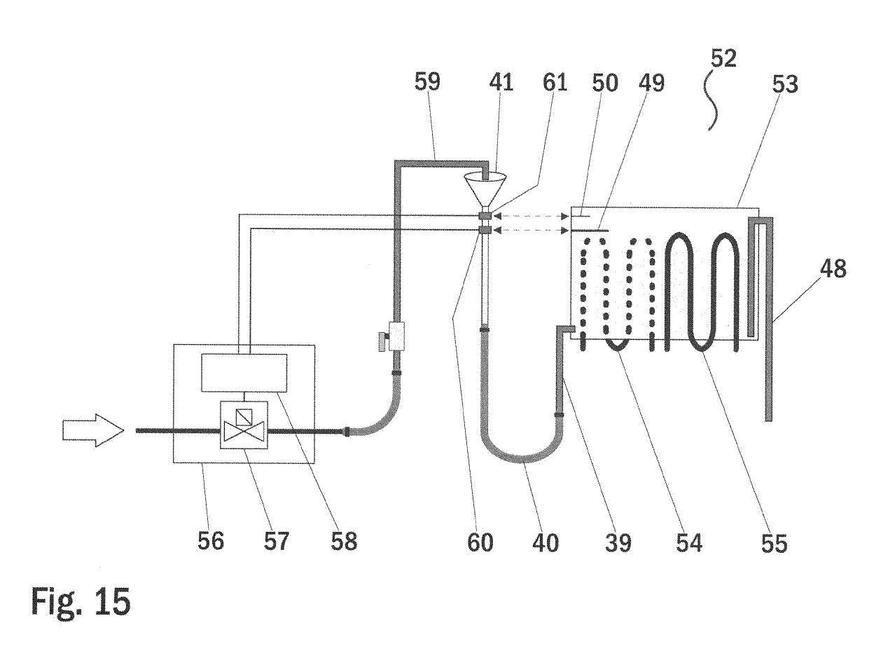

FIG. 15 shows an embodiment for regulating the water level of a water tank of a steam generator element for a sauna electric heater according to the present invention. The steam generator element 52 according to the present embodiment comprises a water tank 53 fillable with water. Said water tank 53 of the said steam generator element 52 is placeable inside the sauna electric heater frame part between at least two of the heating resistor elements 54, 55 of the said sauna electric heater. Said water tank 53 of the said steam generator element 52 according to the present embodiment comprises a heatproof pipe element 39 and/or a heat-proof hose 40. The said heat-proof hose 40 may also have a funnel 41. The steam generator element 52 according to the present embodiment also comprises a heat-proof syphon pipe 48 which said syphon pipe 48 facilitates the emptying of the said water tank 53 of the said steam generator element 52.

Furthermore, the sauna electric heater according to the present embodiment comprises a control unit 56 for regulating the water level of said water tank 53 of said steam generator element 52. The said a control unit 56 may comprise a water inlet 57 to said the sauna electric heater and a control block 58 for controlling the said water inlet 57. The sauna electric heater according to the present embodiment also comprises a water inlet pipe/hose arrangement 59 leading the water from the said water inlet 57 to said heat-proof hose 40 and/or said heat-proof pipe element 39.

Furthermore, the sauna electric heater according to the present embodiment comprises at least two water level sensors 60, 61, each water level sensor 60, 61 of the at least two water level sensors 60, 61 being arranged to detect a level of water in the water tank 53. The said at least two water level sensors 60, 61 may e.g. be a capacitive sensors 60, 61.

When the water tank 53 is filled a first water level sensor 60 of the at least two water level sensors 60, 61 is activated. The said control block 58 of the said a control unit 56 controls the said water inlet 57 until the said first water level sensor 60 detects that the water has risen to a desirable level i.e. to the filling level.

Respectively, when the emptying of the said water tank 53 is initiated a second water level sensor 61 of the at least two water level sensors 60, 61 is activated. The said control block 58 of the said a control unit 56 controls the said water inlet 57 until the said second water level sensor 61 detects that the water has risen to a desirable level i.e. to the draining level. When the water is filled to the draining level marked by said second water level mark 50 the said syphon pipe 48 starts the process of emptying of the said water tank 53,

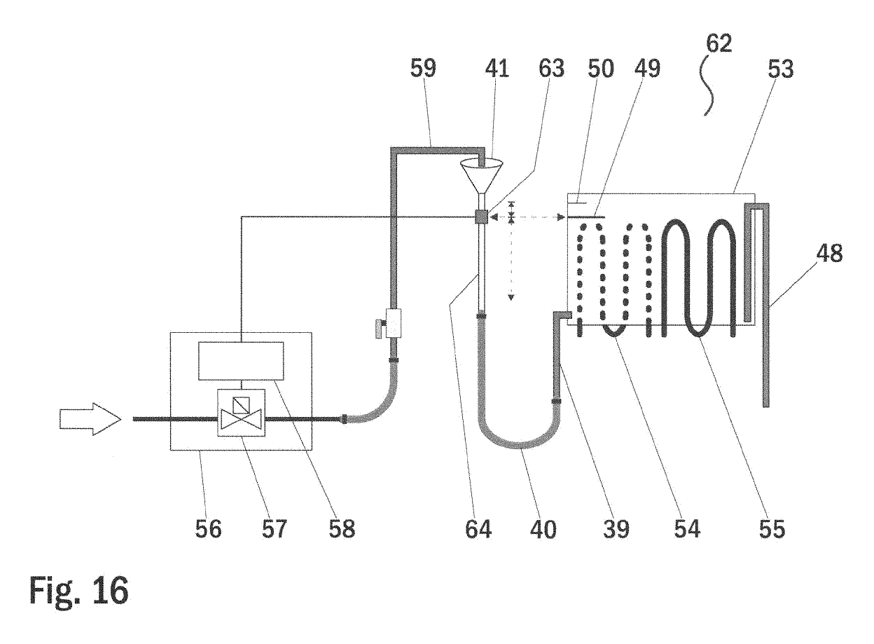

FIG. 16 shows another embodiment for regulating the water level of a water tank of a steam generator element for a sauna electric heater according to the present invention. The steam generator element 62 according to the present another embodiment comprises a water tank 53 fillable with water. Said water tank 53 of the said steam generator element 62 is placeable inside the sauna electric heater frame part between at least two of the heating resistor elements 54, 55 of the said sauna electric heater. Said water tank 53 of the said steam generator element 62 according to the present another embodiment comprises a heat-proof pipe element 39 and/or a heat-proof hose 40. The said heat-proof hose 40 may also have a funnel 41. The steam generator element 62 according to the present another embodiment also comprises a heat-proof syphon pipe 48 which said syphon pipe 48 facilitates the emptying of the said water tank 53 of the said steam generator element 62.

Furthermore, the sauna electric heater according to the present another embodiment comprises a control unit 56 for regulating the water level of said water tank 53 of said steam generator element 62. The said a control unit 56 may comprise a water inlet 57 to said the sauna electric heater and a control block 58 for controlling the said water inlet 57. The sauna electric heater according to the present another embodiment also comprises a water inlet pipe/hose arrangement 59 leading the water from the said water inlet 57 to said heat-proof hose 40 and/or said heat-proof pipe element 39.

Furthermore, the sauna electric heater according to the present another embodiment comprises a movable water level sensor 63 and a sensor pipe 64. The said sensor pipe 64 is connected to one end of said heat-proof hose 40 and/or to one end of said heat-proof pipe element 39. The movable water level sensor 63 is arranged to move up and down along the said sensor pipe 64. The said movable water level sensor 63 may e.g. be a capacitive sensor 63.

When the water tank 53 is filled the said movable water level sensor 63 is moved to the level of a first water level mark 49 showing the filling level of water in the water tank 53. The said control block 58 of the said a control unit 56 controls the said water inlet 57 until the said movable water level sensor 63 detects that the water has risen to a desirable level i.e. to the filling level.

Respectively, when the emptying of the said water tank 53 is initiated the said movable water level sensor 63 is moved to the level of a second water level mark 50 shows the draining level of water in the water tank 53. The said control block 58 of the said a control unit 56 controls the said water inlet 57 until the said movable water level sensor 63 detects that the water has risen to a desirable level i.e. to the draining level. When the water is filled to the draining level marked by said second water level mark 50 the said syphon pipe 48 starts the process of emptying of the said water tank 53.

Furthermore, the said control unit 56 of the sauna electric heater according to the present another embodiment may be used to regulate the amount of steam generated by the said steam generator element 62 by regulating the water level of the said water tank 53 of the said steam generator element 62. When regulating the water level of the said water tank 53, the said movable water level sensor 63 is moved to a desired level lower than said first water level mark 49 showing the filling level of water in the water tank 53. The less steam is desired the lower the water level sensor 63 is moved. The said control block 58 of the said a control unit 56 controls the said water inlet 57 until the said movable water level sensor 63 detects that the water level is at a desirable level. The said control unit 56 may utilize sensors, e.g. temperature sensors and humidity sensors in regulating the amount of steam generated by the said steam generator element 62.

The current steam generator solution according to the present invention can produce soft steam to the sauna and also is simpler in design and has a configuration which is not prone to generating faults and braking up. The current steam generator solution according to the present invention provides more durable operation and with less generated faults and brake ups when compared to the prior art solutions. The water tank according to the present invention may have a holding capacity or 1.0 to 3.0 liters, preferably a holding capacity or 1,5 to 2.0 liters. The steam generator solution according to the present invention can produce steam 12 to 15 minutes from the start. The steam generator solution according to the present invention can produce steam to the sauna up to 75% RH (RH, Relative Humidity) after the first 30 minutes. The steam generator solution according to the present invention can produce steam for 60 to 90 minutes without a need for a refill of water.

Also the sauna electric heater according to the present invention has a steam generator which can produce soft steam to the sauna and also is simpler in design and has a configuration which is not prone to generating faults and braking up. The sauna electric heater according to the present invention provides more durable operation and with less generated faults and brake ups when compared to the prior art solutions.

The solution according to the present invention may be utilized in any kind of sauna solutions having a sauna electric heater. The solution according to the present invention may even be installed to old sauna premises and also even to sauna premises having an old sauna electric heater.

It will be obvious to a person skilled in the art that, as the technology advances, the inventive concept can be implemented in various ways. The invention and its embodiments are not limited to the examples described above but may vary within the scope of the claims.

1. A steam generator element (18), (19), (26), (33), (37), (45), (52), (62) for a sauna electric heater (13), said sauna electric heater (13) comprising a frame part (14), heating resistor elements (15-17), (29), (30), (54), (55) inside the said frame part (14), and sauna stones (2) arranged inside the said frame part (14) and/or on the top part of the said sauna electric heater (13), characterized in that the said steam generator element (18), (19), (26), (33), (37), (45), (52), (62) comprises a water tank (20), (27), (38), (46), (53) fillable with water and being placeable inside the said frame part (14) between at least two heating resistor elements (15-17), (29), (30), (54), (55) and/or said sauna stones (2).

2. A steam generator element (18), (19), (26), (33), (37), (45), (52), (62) according to claim 1, characterized in that the said water tank (20), (27), (38), (46), (53) is manufactured from a metal sheet or from a metal alloy sheet with joined form pressed side plates.

3. A steam generator element (18), (19), (26), (33), (37), (45), (52), (62) according to claim 1, characterized in that it comprises a water tank cover (21), (28), (34), (47) comprising openings (22), (23), (35), (36).

4. A steam generator element (18), (19), (26), (33), (37), (45), (52), (62) according to claim 1, characterized in that the said water tank cover (21), (28), (34), (47) is manufactured from a form pressed metal sheet or from a form pressed metal alloy sheet.

5. A steam generator element (18), (19), (26), (33), (37), (45), (52), (62) according to claim 1, characterized in that the said water tank (20), (27), (38), (46), (53) and/or the said water tank cover (21), (28), (34), (47) comprise one or more water level mark (24), (32), (49), (50).

6. A steam generator element (18), (19). (26), (33), (37), (45), (52), (62) according to claim 3, characterized in that the said water tank cover (21), (28), (34), (47) comprises a recess (25) for a diffuser of oils or solutions.

7. A sauna electric heater (13) comprising a frame part (14), heating resistor elements (15-17), (29), (30), (54), (55) inside the said frame part (14), and sauna stones (2) arranged inside the said frame part (14) and/or on the top part of the said sauna electric heater (13), characterized in that the said sauna electric heater (13) comprises a steam generator element (18), (19), (26), (33), (37), (45), (52), (62) placed inside the said frame part (14) between at least two heating resistor elements (15-17), (29), (30), (54), (55) and/or said sauna stones (2), said steam generator element (18), (19), (26), (33), (37), (45), (52), (62) comprising a water tank (20), (27), (38), (46), (53) fillable with water.

8. A sauna electric heater (13) according to claim 7, characterized in that the said water tank (20), (27), (38), (46), (53) and/or the said water tank cover (21), (28), (34), (47) comprise one or more water level mark (24), (32), (49), (50).

9. A sauna electric heater (13) according to claim 7, characterized in that the said steam generator element (18), (19), (26), (33), (37), (45), (52), (62) comprises: a heat-proof pipe element (39) connected to the bottom part of the said water tank (20), (27), (38), (46), (53); and/or a heat-proof hose (40) comprising a transparent element (43) and a water level mark (44).

10. A sauna electric heater (13) according to claim 7, characterized in that the said steam generator element (18), (19), (26), (33), (37), (45), (52), (62) comprises a heat-proof syphon pipe (48). 11. A sauna electric heater (13) according to claim 7, characterized in that it comprises: a control unit (56) for regulating the water level of said water tank (20), (27), (38), (46), (53) of said steam generator element (18), (19), (26), (33), (37), (45), (52), (62), the said a control unit (56) comprising a water inlet (57) and a control block (58) for controlling the said water inlet (57); and that it comprises a water inlet pipe/hose arrangement (59) leading the water from the said water inlet (57) to said heat-proof hose (40) and/or said heat-proof pipe element (39).

12. A sauna electric heater (13) according to claim 11, characterized in that it comprises at least two water level sensors (60), (61), each water level sensor (60), (61) of the at least two water level sensors (60), (61) being arranged to detect a level of water in the water tank (20), (27), (38), (46), (53).

13. A sauna electric heater (13) according to claim 11, characterized in that it comprises a movable water level sensor (63) and a sensor pipe (64) connected to one end of said heat-proof hose (40) and/or to one end of said heat-proof pipe element (39), the movable water level sensor (63) being arranged to move up and down along the said sensor pipe (64).

14. A sauna electric heater (13) according to claim 12, is characterized in that said movable water level sensor (63) detects when the water has risen to the level of a first water level mark (49) showing the filling level of water in the water tank (20), (27), (38), (46), (53) or to the level of a second water level mark (50) showing the draining level of water in the water tank (20), (27), (38), (46), (53).

15. A sauna electric heater (13) according to claim 13, characterized in that said movable water level sensor (63) detects when the water level is at a desirable level for regulating the amount of steam generated by the said steam generator element (18), (19), (26), (33), (37), (45), (52), (62).
